(19) United States
(12) Patent Application Publication
(10) Pub. No.: US 2023/0164574 A1
(43) Pub. Date: May 25, 2023

(54) FACILITATING ASSIGNMENT OF PHYSICAL CELL IDENTIFIER UNDER TECHNOLOGICAL AND OPERATIONAL CONSTRAINTS

(71) Applicant: AT&T Intellectual Property I, L.P., Atlanta, GA (US)

(72) Inventors: Carlos Eduardo De Andrade, Gainesville, FL (US); Nemmara Shankaranarayanan, Bridgewater, NJ (US); Slawomir Stawiarski, Carpentersville, IL (US)

(21) Appl. No.: 17/532,433

(22) Filed: Nov. 22, 2021

(51) Int. Cl. H04W 16/12; H04W 16/18

(52) U.S. Cl. CPC H04W 16/12; H04W 16/18

(57) ABSTRACT

Facilitating assignment of physical cell identifier under technological and operational constraints provided herein. Operations of a system include identifying a first group of network equipment that includes a first relationship status and a second group of network equipment that includes a second relationship status different than the first relationship status. The operations also can include determining a first assignment of first identifiers of a group of identifiers for the first group of network equipment based on a first application of first assignment conflicts. Further, the operations can include determining a second assignment of second identifiers of the group of identifiers for the second group of network equipment based on a second application of second assignment conflicts. In an example, determining of the first assignment of first identifiers includes resolving module-k conflicts among the first group of network equipment.

### TECHNICAL FIELD

This disclosure relates generally to the field of network configuration and, more specifically, to facilitating physical cell identity assignment of cells, e.g., in fifth generation (5G) or other advanced networks.

### BACKGROUND

Physical Cell Identity (PCI) assignments are necessary for network deployment. PCI is the identifier of a cell in the physical layer of a 5G network. The total number of PCIs in 5G are limited to 1008. Thus, the PCIs need to be reused and several cells in a network will share the same PCI. PCI conflicts in PCI code allocation result in network performance degradations in UE cell (re)selections, handovers, user equipment synchronization, and radio frequency condition status estimates. PCI conflicts include PCI collisions and PCI confusions.

Accordingly, unique challenges exist associated with network configuration and PCI assignment in advanced networks.

### BRIEF DESCRIPTION OF THE DRAWINGS

Various non-limiting embodiments are further described with reference to the accompanying drawings in which:

FIG. 1A illustrates a schematic representation of physical cell identity collision that can occur between two cells in a communications network;

FIG. 1B illustrates a schematic representation of physical cell identity confusion that can occur based on a same physical cell identity being assigned for neighbors of a cell in a communications network;

FIG. 2A illustrates a cluster with five cells and depicts a module-4 collision scenario;

FIG. 2B illustrates the cluster of five cells and depicts the top neighbors among the cells;

FIG. 3 illustrates a confusion scenario in a network having three cells and a user equipment is requesting a hand off between cells;

FIG. 4 illustrates an example, non-limiting, representation of operation constraints related to batch deployment;

FIG. 5A illustrates a first example of a physical cell identity shuffle;

FIG. 5B illustrates a second example of a physical cell identity shuffle;

FIG. 6 illustrates an example, non-limiting, process flow for implementing physical cell identity assignment and deployment separately, according to one or more embodiments;

FIG. 7 illustrates an example, non-limiting, process flow for implementing physical cell identity assignment and deployment together, according to one or more embodiments;

FIG. 8 illustrates an example, non-limiting, computer-implemented method for facilitating physical cell identity assignments based on node classification in accordance with one or more embodiments described herein;

FIG. 9 illustrates an example, non-limiting, computer-implemented method for facilitating deployment of physical cell identities based on batch processing in accordance with one or more embodiments described herein;

FIG. 10 illustrates an example, non-limiting, system that facilitates physical cell identity assignment and deployment in accordance with one or more embodiments described herein;

FIG. 11 illustrates an example, non-limiting, block diagram of a handset operable to engage in a system architecture that facilitates wireless communications according to one or more embodiments described herein; and

FIG. 12 illustrates an example, non-limiting, block diagram of a computer operable to engage in a system architecture that facilitates wireless communications according to one or more embodiments described herein.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details (and without applying to any particular networked environment or standard).

Described herein are systems, methods, articles of manufacture, and other embodiments or implementations that can facilitate assignment of physical cell identifiers under technological and operational constraints. Physical Cell Identity (PCI) and Root Sequence Index (RSI) assignments are necessary for network deployment. In addition, to keep the deployment and operational costs low, the PCI/RSI assignment process should be optimized and automated.

In communication networks, a cell is assigned a PCI and a User Equipment (UE) can read the PCI when the UE sync-ups with the network (e.g., network equipment) in order for the UE to be able to receive downlink data from the network. The UE also gains uplink access to the network based on random access preambles which are generated based on RSI of the cells. Thus, PCI and RSI assignment are utilized in order for a 5G network to be operational.

Several rules should be followed in PCI/RSI assignment for maintaining good network performance. Due to the limited number of PCI/RSI codes, different cells may have to use the same PCI/RSI codes in the network. However, not every cell can use the same PCI/RSI. For example, a 5G cell cannot have two neighboring cells assigned with the same PCI. Thus, PCI/RSI assignment can be modeled as an optimization problem where PCI/RSI reuse distance (e.g., the distance between two cells sharing the same PCI/RSI) is maximized while multiple assignment rules are followed. The various aspects provided herein allocate PCIs to 5G cells, so as to avoid and/or minimize PCI conflicts.

An embodiment relates to a method that includes determining, by a system including a processor, that first nodes of a group of nodes satisfy a defined threshold criterion and that second nodes of the group of nodes fail to satisfy the defined threshold criterion. The method also includes determining, by the system, first assignment conflicts at the first nodes based on a first weight, and second assignment conflicts at the second nodes based on a second weight that is different than the first weight. Further, the method includes assigning, by the system, physical cell identifiers to the group of nodes. The assigning includes assigning respective first physical cell identifiers of the physical cell identifiers to the first nodes based on the determining of the first assignment conflicts. The assigning also includes assigning respective second physical cell identifiers of the physical cell identifiers to the second nodes based on the determining of the second assignment conflicts. Assignment of the respective second physical cell identifiers is after completion of the assigning of the respective first physical cell identifiers.

In some implementations, the method can include categorizing, by the system, the first nodes and the second nodes into batches. The categorizing is based on minimization of an interdependency between the batches. The method also can include facilitating, by the system, deployment of the respective first physical cell identifiers to the first nodes, and deployment of the respective second physical cell identifiers to the second nodes based on a determined order of the batches. Further to these implementations, the deployment can include minimizing a physical cell identifier shuffle caused by an order of the deployment of the batches.

Determination of the first assignment conflicts and the second assignment conflicts can include determining first module-k assignments for the first nodes and second module-k assignments for the second nodes. The first assignment conflicts include first collisions resulting from first neighboring nodes of the first nodes determined to be assigned a first same physical cell identifier, and the second assignment conflicts include second collisions resulting from second neighboring nodes of the second nodes determined to be assigned a second same physical cell identifier.

In some implementations, the second weight has a lesser importance than the first weight. Further to these implementations, based on the second weight, a module-k conflict is allowed for the second node.

According to an example, the defined threshold criterion includes a defined performance indicator associated with neighboring nodes of the group of nodes. In another example, the first nodes are classified as principal neighbor nodes, and the second nodes are classified as common neighbor nodes. Further, assigning the first physical cell identifiers and the second physical cell identifiers can include mitigating direct collisions between the group of nodes.

Another embodiment relates to a system that can include a processor and a memory that stores executable instructions that, when executed by the processor, facilitate performance of operations. The operations can include identifying a first group of network equipment that includes a first relationship status and a second group of network equipment that includes a second relationship status different than the first relationship status. The operations also can include determining a first assignment of first identifiers of a group of identifiers for the first group of network equipment based on a first application of first assignment conflicts. Further, the operations can include determining a second assignment of second identifiers of the group of identifiers for the second group of network equipment based on a second application of second assignment conflicts. In an example, determining of the first assignment of first identifiers includes resolving module-k conflicts among the first group of network equipment.

In some implementations, the first application of first assignment conflicts includes applying a first rule associated with a module-k assignment to the first group of network equipment. The second application of second assignment conflicts includes a second rule associated with the module-k assignment to the second group of network equipment. The second rule can be less stringent than the first rule.

According to some implementations, the operations can include applying batch processing of first network equipment of the first group of network equipment and second network equipment of the second group of network equipment, resulting in batches of network equipment. The batches of network equipment include a first batch of network equipment and at least a second batch of network equipment. Applying the batch processing includes mitigating an interdependency between the first batch of network equipment and at least the second batch of network equipment. Further to these implementations, the operations can include, based on the applying, deploying the first assignment of first identifiers at the first group of network equipment and the second assignment of second identifiers at the second group of network equipment. Further, in some implementations, mitigating of the interdependency includes ordering a deployment of the batches of network equipment based on minimization of a physical cell identifier shuffle among the batches of network equipment.

In accordance with some implementations, the operations can include determining the first relationship status based on a performance indicator.

Another embodiment relates to a non-transitory machine-readable medium, including executable instructions that, when executed by a processor, facilitate performance of operations. The operations can include determining first assignment conflicts among first network equipment determined to be first neighboring equipment supporting a first performance indicator, and second assignment conflicts between second network equipment determined to be second neighboring equipment supporting a second performance indicator. The operations also can include, based on the first network equipment having a higher priority assignment as compared to the second network equipment, establishing an assignment list for the first network equipment and the second network equipment. The assignment list is configured to resolve the first assignment conflicts and the second assignment conflicts. The higher priority assignment is determined based on the first performance indicator. Further, the operations can include facilitating a deployment of the assignment list for the first network equipment and the second network equipment based on the establishing.

In an implementation, facilitating the deployment can include grouping the first network equipment and the second network equipment based on minimization of shuffling of the assignment list. The shuffling is caused by two or more network equipment having a same identifier after the deployment. In some implementations, the assignment list includes an assignment of respective physical cell identifiers to the first network equipment and the second network equipment.

As mentioned, the Physical Cell Identifier (PCI) is an important parameter of Radio Access Networks (RAN). The PCI is related to the random access procedure for establishing download channels between User Equipment (UE) and network equipment (e.g., a base station, a cell, and so on). Since cells (or network equipment) often have overlap on their coverage area, they are referred to as neighbor cells. Thus, different PCIs should be assigned to neighbor cells so that a UE can connect to the correct cell. If not, collision and/or confusion may occur.

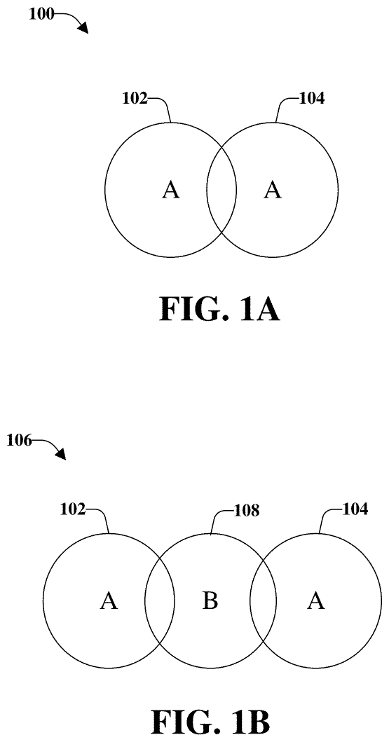

Several rules should be followed during PCI assignment. First, PCI collisions should be avoided. A PCI collision is defined as when two neighboring cells (e.g., two 5G neighboring cells) are assigned with the same PCI. For example, FIG. 1A illustrates a schematic representation of Physical Cell Identity (PCI) collision that can occur between two cells in a communications network 100. As depicted in FIG. 1A, the first circle represents a first cell 102, which is assigned PCI A. The second circle represents a second cell 104, which is also assigned PCI A. As illustrated, at least a portion of a coverage area of the first cell 102 and at least a portion of a coverage area of the second cell 104 overlap. Accordingly, a UE at the two neighboring cells will not be able to synchronize with the network since the UE cannot distinguish the first cell 102 from the second cell 104. Therefore, no adjacent cells should have the same PCI.

Secondly, PCI confusions should also be avoided. A PCI confusion is defined as when two cells with the same PCI are not neighbors, but share a same neighbor. FIG. 1B illustrates a schematic representation of PCI confusion that can occur based on a same PCI being assigned for neighbors of a cell in a communications network 106. For example, illustrated are the first cell 102, the second cell 104, and a third cell 108. The first cell 102 and the second cell 104 are assigned PCI A. The third cell 108 is assigned PCI B. PCI confusion occurs because PCI A is assigned to two cells (e.g., the first cell 102 and the second cell 104), which share the same neighbor (e.g., the third cell 108). In the case of PCI confusions, a UE at the third cell 108 (e.g., PCI B) will not be able to complete handovers to either of the two neighboring cells. This is because the UE is confused on which cell to handover to since the neighboring cells have the same assigned PCI. Therefore, a cell cannot have two neighbors sharing the same PCI.

To correctly define collisions and confusions, the concept of neighboring cells is used. Two cells are considered neighbors when they exchange UEs. For example, a UE moves from one cell (e.g., an origin cell) to another cell (e.g., an entrance cell) and requests that the origin cell hand over the connection to the entrance cell. Usually, neighboring cells have some overlap in their coverage, but do not need to have overlap.

A direct collision occurs when neighboring cells have the same PCI. In such a case, the UE cannot determine precisely to which cell it is to connect, and therefore, the connection cannot be established (e.g., the UE cannot connect to either cell).

While collisions prevent a UE from connecting to the network, confusions prevent handovers between cells. A confusion occurs when a cell has two neighbors with the same PCI. When a UE asks for handover, the network equipment (e.g., base station) does not know to which cell it should hand the UE over. Confusions also can happen when a 4G cell has 5G neighbors with the same PCI. This situation is called Inter-Technology Neighbors (ITNs) confusion.

Also, due to constraints in a primary and second synch signal and the 5G numerology, neighboring PCIs should be different in modules. Based on the design of different physical layer signals (e.g., Primary Synchronization Signal (PSS), Demodulation Reference Signal (DMRS), and Sounding Reference Signal (SRS)), channels (e.g., Physical Uplink Shared Channel (PUSCH) and Physical Uplink Control Channel (PUCCH)) and time-frequency allocation, PCI planning should consider following Mod to reduce interference. As per the Mod Principle, the UE should not be able to simultaneously receive multiple PCI with following modes: PCI Mod 3; PCI Mod 4; and PCI Mod 30.

In an example of “Mod 3 PCI,” the neighboring cell should be allocated PCI 25 and 28 because both has Mod 3 as value 1. The PCI Mod 3 rule is based on a relationship between PCI and sequence generated by PSS. There are 3 PSS (0, 1, 2) which are reused across the network. The cells having the same ‘PCI Mode 3’ result will use the same PSS and simulation results has shown that if a UE receive the same PSS from multiple cells, it results in delay in cell acquisition and misleading channel estimation. Overall, it will have an impact on synchronization delay and user experience.

The PCI Mod 4 rule is based on subs-carrier positions of DMRS for PBCH (Physical Broadcast Channel). The subcarriers are allocated to DMRS using ‘Mod 4’ computation. If a neighboring cell uses a PCI having the same Mod 4 value, it results in DMRS to DMRS interference.

For PCI Mode 30, DMRS for PUCCH and/or PUSCH and SRS based on the ZC (Zadoff-Chu) sequence, there are 30 groups of roots. The roots are associated with the PCI. Therefore, the neighbor cell should not have PCIs having the same Mod 30 value to ensure the uplink inter cell interference.

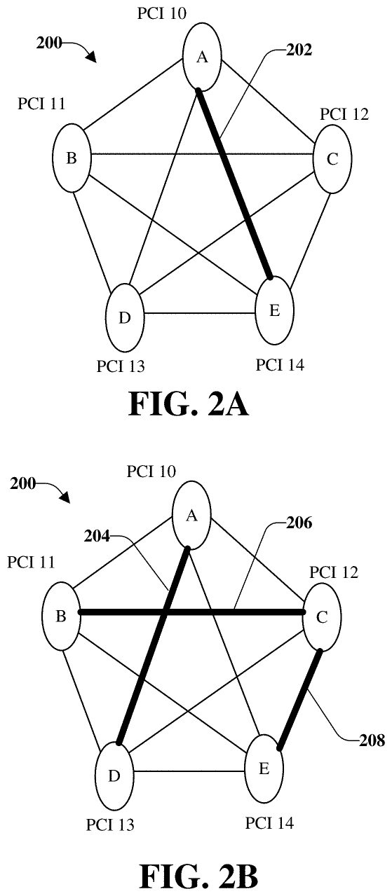

However, it can be difficult to ensure module 3 and module 4 assignments in large production networks. The reason is that it is common to have a cluster of size more than or equal to 5 (>5) in which all cells are neighbors of the other cells within the cluster. For example, FIG. 2A illustrates a cluster 200 with five cells and depicts a module-4 collision scenario. The cells are identified as cell A, cell B, cell C, cell D, and cell E. Cell A is assigned PCI 10, cell B is assigned PCI 11, cell C is assigned PCI 12, cell D is assigned PCI 13, and cell E is assigned PCI 14. The lines between the cells indicate the neighbor relationship between the cells. In this case, all the cells are neighbors of one another. Thus, if the cells are considered nodes and the neighborhood relationships are considered edges in a neighboring graph, it is common to find cliques of size five plus (5+). In these cases, at least the size-of-the-largest-clique colors (or PCIs) is needed to find a feasible assignment.

However, it is impossible to find a module-4 assignment for more than 4 cells, since the mathematical operator module will define only 4 colors (0, 1, 2, and 3, the remainders of an integer division by 4). In FIG. 2A, there would be a module-4 collision between cell A (PCI 10) and cell E (PCI 14), as indicated by line 202 (e.g., 10=14 (mod 4)). A module-4 assignment can be found because there should be at least five module-4 different colors/PCIs, as discussed above.

Therefore, instead of enforcing module assignment on all edges/neighbors, as provided herein, the enforcement is performed only for a reduced number of edges, referred to as top neighbors. Cell A is a top neighbor of cell B only if a given threshold for a given key performance indicator (KPI) is reached. For example, it can be stated that the top neighbor for a cell is the neighboring cell for which most handovers occur.

For each cell, the neighbors are ranked based on the chosen KPIs and thresholds (can be more than one), and a given number of neighbors is chosen as top neighbors. This relation may not be necessarily symmetric. For example, cell A may be a top neighbor of cell B, but cell B may not be a top neighbor of cell A.

FIG. 2B illustrates the cluster 200 of five cells and depicts the top neighbors among the cells. The top neighbors are indicated as follows: cells A, D are top neighbors, as indicated by line 204; cells B, C are top neighbors, as indicated by line 206; and cells C, E are top neighbors, as indicated by line 208. The determination of the top neighbors for FIG. 2B is as follows:

### Top Neighbors

A,D->10≠13 (mod 4) OK!
B,C->11≠12 (mod 4) OK!
C,E->12≠14 (mod 4) OK!

The determination of the regular (or common) neighbors for FIG. 2B is as follows:

### Regular Neighbors

A, B->10≠11 OK!
A, C->10≠12 OK!
A, E->10≠14 OK!
B, D->11≠13 OK!
B, E->11≠14 OK!
C, D->12≠13 OK!
D,E->13≠14 OK!

Accordingly, the disclosed embodiments are configured to guarantee module-k collision-free assignment for all pairs of top neighbors (making it generic for any module k). This is referred to as a hard constraint herein. For all other pairs of neighbors (or edges), denominated as regular neighbors, the disclosed embodiments minimize as much as possible the module-k collisions. However, for all pairs of neighbors, the disclosed embodiments should guarantee that there are no direct collisions (e.g., all pairs of nodes are to have different PCIs). This is also referred to as a hard constraint.

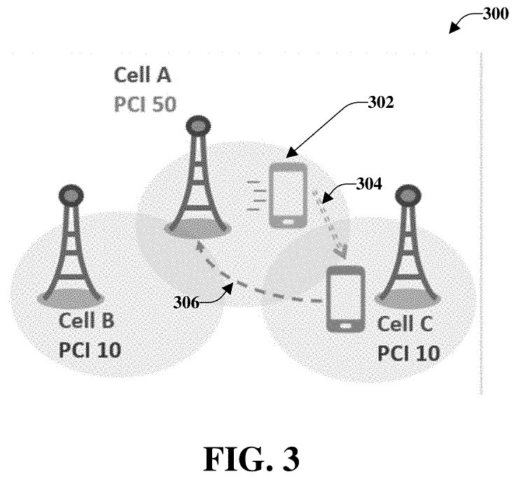

As mentioned above, confusion occurs when a cell has two neighbors with the same PCI. When a UE asks for handover, the base station does not know to which cell it should hand over the UE. In other words, if second-level neighbors (neighbor of neighbors) have the same PCI as that of the current cell, confusion may occur. For example, FIG. 3 illustrates a confusion scenario in a network 300 having three cells and a UE is requesting a hand off between cells. In the example of FIG. 3, Cell A is assigned PCI 50; Cell B is assigned PCI 10; and Cell C is assigned PCI 10. As indicated, a UE 302 is currently connected to Cell A and wants to hand over to Cell C, as indicated by arrow 304. In order to identify Cell C, the UE requests to be handed over to cell PCI 10, as indicated by arrow 306. For example, the UE asks Cell A to hand the connections over to the cell with PCI 10 (remember, the only identification the UE knows about the cell is its PCI). However, Cell A cannot determine whether UE is referring to Cell B or Cell C since they have the same PCI.

It is noted that confusion occurs only when the same-PCI neighbors of a cell are not direct neighbors among themselves. Otherwise, a collision would occur. In this example, Cells B and C are not direct neighbors but second-level neighbors through Cell A. Therefore, an objective of the embodiments provided herein to avoid all confusions. This is a hard constraint.

Thus, as discussed herein there are some constraints considered to be hard technological constraints which include: avoiding direct PCI conflicts among all neighboring cells; avoiding module-k PCI conflicts for top neighbors; and avoiding confusions. Further, technological objective functions as discussed herein are minimizing the module-k conflicts for regular neighbors.

While the technological constraints are known, the actual deployment of a PCI assignment is guided by some operation constraints. First, there may be blocked cells, which are cells for which the PCI are not to be changed. Such cells are to be considered during optimization since their neighbors may need a PCI change. Second, the network operators usually want to minimize the number of changes performed in the network. Third, the deployment should be performed using small batches. For example, while the PCI assignment is improved for a large portion of the network, at the same time, the changes are delivered within groups of nodes with limited size sequentially, as discussed herein.

Mitigating and/or reducing the numbers of nodes for whose PCI are changed and delivering small batches allow for retaining tight track of the network effects after the change. This also minimizes issues and outages, making possible rollbacks available in the case of failure, and mitigating and/or reducing resource utilization (e.g., it is “expensive” to send commands to ENMs and Netacts).

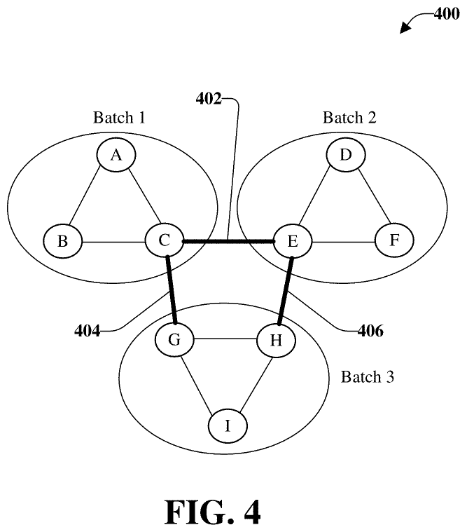

FIG. 4 illustrates an example, non-limiting, representation of operation constraints related to batch deployment. When PCI changes are to be deployed, they are grouped on small batches which are submitted sequentially to the Element Network Manager (ENM). These batches have a maximum size or capacity due to limitations on the ENM and the reasons stated above.

Nodes in different batches may have a dependency (e.g., they may have neighborhood relations among themselves). For example, PCIs for nodes are to be changed from A to I. For purposes of explanation, the maximum batch size is 3. Therefore, the nodes are split into 3 groups: batch 1 {A, B, C}, batch 2 {D, E, F}, and batch 3 {G, H, I}. Note that there are interdependencies between the batches on pairs (C, E), (C, G), and (E, H), indicated by lines 402, 404, and 406, respectively. For such nodes, extra care should be taken when changing the PCIs.

When scheduling batches, a PCI shuffle may occur. A PCI shuffle is when a node receives the PCI number previously assigned to a neighbor or a second neighbor, which is assigned to another batch. Since the batches are deployed in sequence, collisions and/or confusions might result. Therefore, the ENM will fail on validating the deployment.

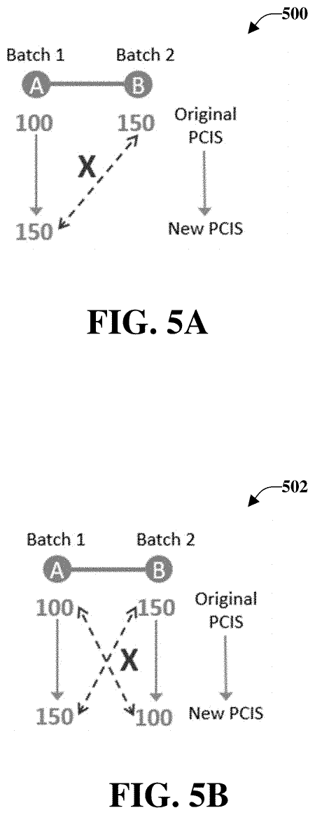

FIG. 5A illustrates a first example 500 of a PCI shuffle. There are two neighboring cells A and B, whose PCIs is to be changed. The original PCI for cell A is 100, and for cell B is 150. Now, suppose that PCI 150 is to be assigned for cell A. Since cells A and B are in different batches, batch 1 cannot be deployed first because it will cause a PCI collision with cell B, even though the PCI for B should be changed later on.

FIG. 5B illustrates a second example 502 of a PCI shuffle. Here, PCI 150 is to be assigned to cell A and PCI 100 is to be assigned to cell B. In this case, it does not matter the order in which the batches are deployed because collisions will happen in any case.

Thus, to avoid PCI shuffles in the first case (first example of FIG. 5A), proper order of the batches for delivery are determined. In the second case (second example of FIG. 5B), dependent nodes (for which the PCIs are to be changed) are assigned in the same batch. However, each batch has a limited size or capacity. Therefore, it can be challenging to find a proper packing.

Thus, as discussed above there are operational constraints which include hard technological constraints. Examples of hard technological constraints are that locked cells cannot be changed, changes are to be deployed in batches with a limited size, avoidance of PCI shuffle. Further operational constraints include technological objective functions. Examples of technological objective functions include minimizing the number of changes (e.g., the number of cells for which the PCI is to be changed), order the batches to avoid PCI shuffle deployment issues, and minimize the number of batches.

Accordingly, as will be discussed in further detail below, the disclosed embodiments are configured to abide by various hard constraints including avoiding direct PCI conflicts among all neighboring cells and avoiding module-k PCI conflicts for top neighbors. Further, confusions should be avoided. Locked cells cannot be changed, and changes are to be deployed in batches with a limited size. Additionally, PCI shuffle should be avoided.

The disclosed embodiments also minimize the module-k conflicts for regular neighbors. Further, the disclosed embodiments minimize the number of changes (e.g., the number of cells for which the PCI is to be changed). Further, the disclosed embodiments minimize the number of batches. Further details will be provided below.

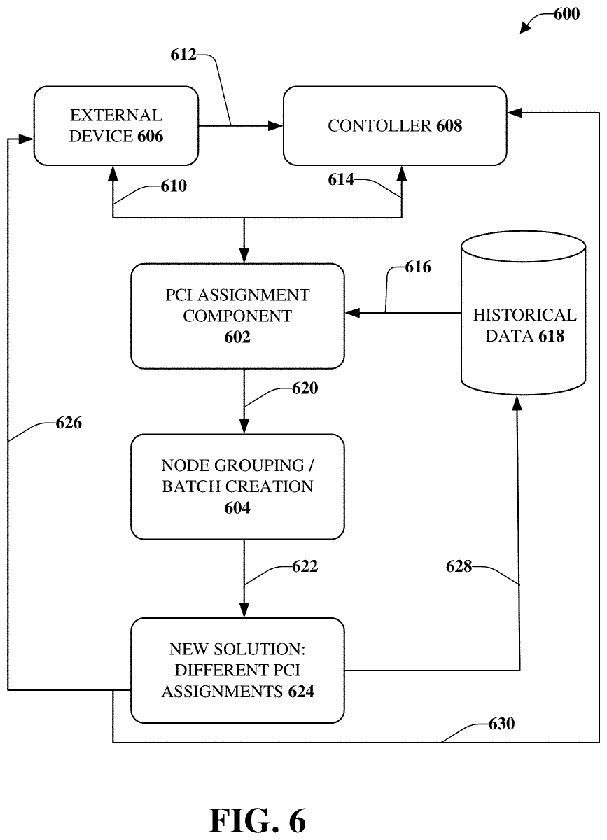

FIG. 6 illustrates an example, non-limiting, process flow 600 for implementing physical cell identity assignment and deployment separately, according to one or more embodiments. The process flow 600 includes a PCI assignment phase component 602 and a node grouping and/or batch creation phase component 604 in accordance with one or more embodiments provided herein. An advantage of the embodiment of FIG. 6 is that the PCI assignment problem is easier to solve since it does not contain grouping constraints. In this way, generic or out-of-the-shelf PCI assignment processes can be utilized. However, the grouping phase may generate imbalanced batches or interdependencies between batches that cannot be solved (and, therefore, not deployed automatically).

One or more input devices, illustrated as an external device 606 and a controller 608, can trigger PCI optimization as discussed herein. Although illustrated as two input devices, fewer or more input devices can be utilized with the disclosed embodiments. Two input devices are illustrated and described to discuss separately the input received via an external source and an internal source. For example, the external device 606 can trigger the PCI optimization based on receipt of manual input and the controller 608 can trigger the PCI optimization autonomously.

The input devices can be associated with one or more entities. As utilized herein an entity can be one or more computers, the Internet, one or more systems, one or more commercial enterprises, one or more computers, one or more computer programs, one or more machines, machinery, one or more actors, one or more users, one or more customers, one or more humans, and so forth, hereinafter referred to as an entity or entities depending on the context. As discussed above, the external device 606 can be associated with manual input (e.g., an entity associated with a network operator manually requests the PCI optimization). The manual input from the external device 606 can be communicated directly to the PCI assignment phase component 602 (also sometimes referred to as a solver), as indicated by line 610. Alternatively, or additionally, the manual input from the external device 606 can be communicated to the PCI assignment phase component 602 via the controller 608, as indicated by line 612.

The controller 608 is associated with a system and/or controller that triggers or implements the PCI assignment autonomously and/or based on receipt of input from the external device 606. The communication from the controller 608 to the PCI assignment phase component 602 is indicated by line 614. For example, the controller 608 can trigger the PCI assignment phase component 602 automatically (e.g., automated close loop) when an invalid PCI assignment is determined and/or when new network equipment (e.g., new radios) are detected in the communication network.

Based on the request from the external device 606 (via line 610) and/or the request from the controller 608 (via line 614), the PCI assignment phase component 602 is triggered. In further detail, when triggered either by the external device 606 or by the controller 608, various information is sent to the solver (e.g., the PCI assignment phase component 602). The various information can include information indicative of a first listing (e.g., a first data structure) of a first set of nodes, information indicative of a second listing (e.g., a second data structure) of a second set of nodes, one or more indications of PCI distance, at least one indication of an allowed PCI range, an optimization sense, and stopping criteria.

The information indicative of the first listing of a first set of nodes can be identification information related to the nodes for which the PCI is to be changed. The information indicative of the second listing of a second set of nodes can be identification information related to the nodes for which the PCI is not to be changed. The nodes for which the PCI is not to be changed can represent blocked cells. In some implementations, there are no nodes for which the PCI is not to be changed (e.g., an empty set, or there are no nodes indicated). Even though these nodes have their PCI fixed, such nodes play a role during the optimization for their no-fixed neighbors (e.g., non-blocked cells).

The PCI assignment phase component 602, can retrieve, at 616, historical data 618 from one or more storage devices, which can be storage devices that are integrated with the system, or external storage devices that are accessible by the system. Included in the historical data 618 can be information related to previous assignments, regardless of whether such previous assignments were deployed or were not deployed. However, only solutions containing the current nodes are used. Further, both deployed and not deployed solutions are used. These solutions work as warm starters to the current optimization process.

The PCI assignment phase component 602 generates a collection of possible solutions. The generation of the collection of possible solutions can be based upon the historical data 618 as well as other data. For example, the PCI assignment phase component 602 can apply a set of processes (discussed further below) for optimizing the assignment according to the optimization criteria. For example, the optimization criteria can include, but is not limited to, input parameters such as module-K.

The PCI assignment phase component 602 (e.g., a planner component) can determine and return one or more feasible solutions or might not be able to determine a feasible solution. Upon or after determining one or more optimized feasible solutions, the PCI assignment phase component 602 returns only the non-dominated ones (e.g., solutions in the Pareto frontier). Such non-dominated solutions are transmitted to the node grouping and/or batch creation phase component 604, as indicated at line 620.

When the PCI assignment phase component 602 cannot find a feasible solution, two situations can occur. The first situation is the PCI assignment phase component 602 proves that the problem instance is infeasible (e.g., there is no feasible solution). Then, the PCI assignment phase component 602 sends an infeasibility proof to the user/controller (e.g., the external device 606 and/or the controller 608). In the second solution, the PCI assignment phase component 602 does not prove infeasibility. In this case, the PCI assignment phase component 602 sends a message or other notification to the user/controller (e.g., the external device 606 and/or the controller 608) stating that no feasible solution was found, but that such solutions could exist.

Upon or after the PCI assignment phase component 602 determines a solution, the information related to the assignment is sent to the node grouping/batch creation component 704, at 620. The node grouping/batch creation component 704 can deploy the assignment in batches or groups of nodes. Mitigating and/or reducing the numbers of nodes for whose PCI are changed and delivering small batches allow for retaining tight track of the network effects after the change. This also minimizes issues and outages, making possible rollbacks available in the case of failure, and mitigating and/or reducing resource utilization.

For example, the node grouping (e.g., the batch creation phase component 604) can split the nodes into groupings such that interdependencies between the groupings (or batches) is minimized as much as possible in order to mitigate and/or reduce PCI shuffling. The information related to the assignment and/or the batch creation is provided, at 622, as a new solution and/or different PCI assignments 624.

If the process was triggered via the external device 606, the generated non-dominated solutions (in the Pareto frontier) are sent to the external device 606, at 626, for validation. Once a solution has been chosen via the external device 606, the selection is sent, at 612, to the controller 608. The controller 608 can be configured to deploy the solution. Further, all generated solutions (the accepted and the rejected) are sent, at 628 to be logged in a database as historical data 618 for posterior use.

In further detail, an entity receives the optimization results from the solver (e.g., the PCI assignment phase component 602). If the response contains one or more feasible solutions, the entity selects the solution desired to be deploy and sends the selected solution over to the controller (at 612). This solution is marked as “used/desired” and the others are marked as “not used”, and logged in the database (e.g., as historical data 618). If the response states infeasibility, the entity can check the root cause and resubmit the optimization request relaxing the constraints (at 610). If the response states “no feasible solution found but feasible solutions can exist,” the entity either can relax the constraint as in the previous step, or resubmit the optimization allowing more time for the optimization run.

Alternatively, at 630, when triggered by the controller, the optimizer sends the non-dominated solutions to the controller 608. Once the entity picks a solution, the chosen solution is sent to the controller, at 612, to deploy the solution. At 628, all generated solutions (the accepted and the rejected) are logged in the database for posterior use.

In further detail, the controller receives the optimization results from the solver (automated closed-loop). If the response contains one or more feasible solutions, the controller chooses the solution while minimizing the total number of module-k collisions in regular neighbors, the number of shuffles, and the number of changes.

When a solution is accepted, this solution is marked as “used/desired,” and the others are marked as “not used” and logged in the database (at 628). If the response states “infeasible” or “no feasible solution was found, but feasible solutions may exist,” the solver can gradually relax the constraints and resubmit to optimization iteratively (at 610 or 614). If a maximum number of failures is reached, a warning message can be sent to the operator for manual optimization.

With respect to FIG. 6, it is noted that there is a PCI assignment optimization phase, which only assigns the PCIs according to various criteria. Such criteria can include avoiding direct PCI conflicts among all neighboring cells; avoiding module-k PCI conflicts for top neighbors; locked cells cannot be changed; minimize the module-k conflicts for regular neighbors; minimize confusions; and minimize the number of changes.

In the group phase, a process is applied that attempts to gather as many nodes with interdependence as possible within the same batch, trying to avoid as much as possible PCI shuffles. This phase abides the following: changes are deployed in batches with a limited size; avoidance of PCI shuffle; order the batches to avoid PCI shuffle deployment issues; and minimize the number of batches.

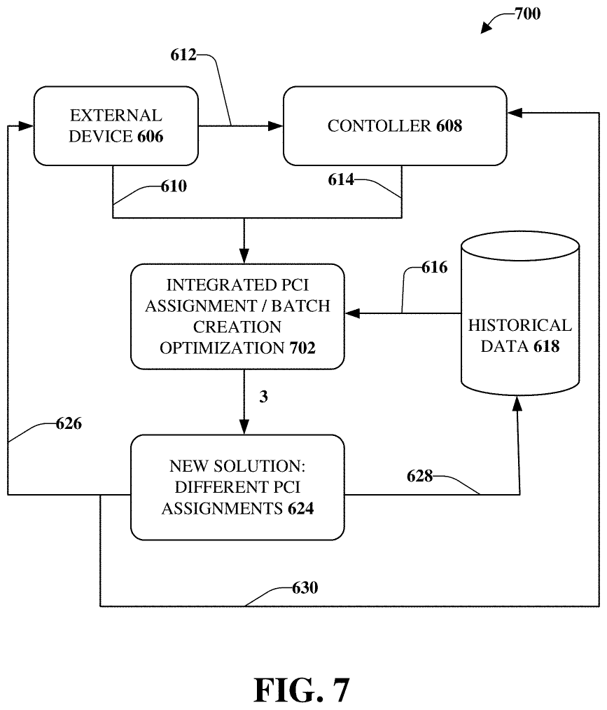

FIG. 7 illustrates an example, non-limiting, process flow 700 for implementing physical cell identity assignment and deployment together, according to one or more embodiments. In order to address the above noted problems as well as other concerns, another embodiment provided herein relates to optimizing or improving both PCI assignment and node grouping in a single step in a combined manner. The advantage of this embodiment is the interdependency among the batches is treated as a hard constraint, and the PCI assignment is performed in view of these restrictions. However, this is a much more complex problem to solve, and custom processes, constraint programming, and/or mixed-integer programming models are utilized. This embodiment can generate better batches and fewer issues, which enables more automation.

The flow diagram is similar to the process flow 600 of FIG. 6, and such details will not be repeated for purposes of brevity. In this embodiment, the PCI assignment and batch creation optimization are integrated into a single optimization phase 702. All the constraints and objective functions are handled at the same time. According to an implementation, objective functions are considered as non-dominant ones, and therefore, generate a Pareto frontier, where the user/controller can pick and choose the solution. In an alternative implementation, the objective functions are considered with a strict dominance relation, where the user/controller defines a priority of importance order on which objective functions is to be optimized first.

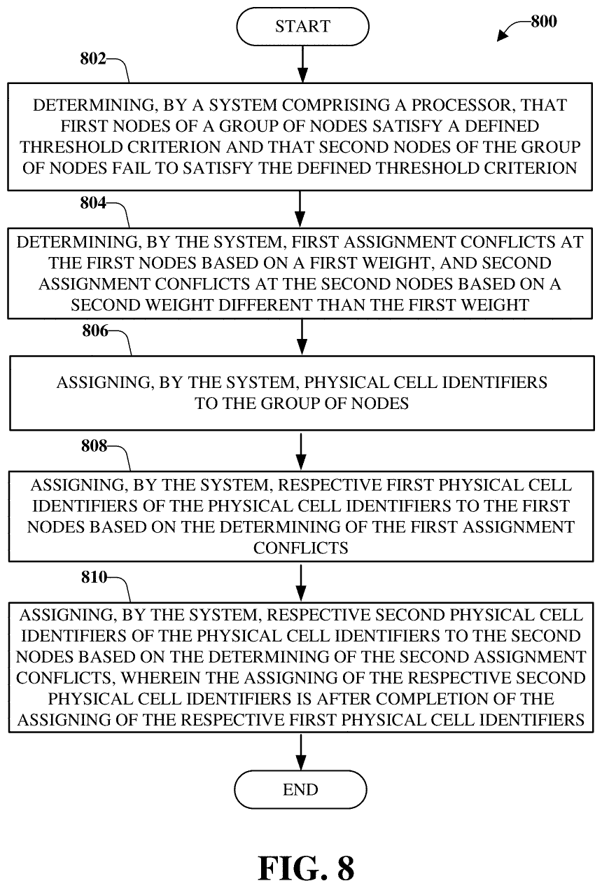

FIG. 8 illustrates an example, non-limiting, computer-implemented method 800 for facilitating PCI assignments based on node classification in accordance with one or more embodiments described herein. The computer-implemented method 800 can be implemented by a system including a memory and a processor, network equipment including a memory and a processor, a network controller including a memory and a processor, or another computer-implemented device including a memory and a processor.

The computer-implemented method 800 starts at 802 with a determination that first nodes of a group of nodes satisfy a defined threshold criterion and that second nodes of the group of nodes fail to satisfy the defined threshold criterion. The threshold criterion can be based on a performance indicator (or a key performance indicator) in the radio access network. The determination of the performance indicator can be based on a given situation (e.g., a number of users in a given cell). In an example, the performance indicator can be a defined quantity of handovers of user equipment between two or more nodes, such as discussed with respect FIG. 2B. The defined quantity of handovers can be configurable and can be based on a ranking of the number of the handovers for the nodes under consideration, wherein a top number of nodes (e.g., five nodes, seven nodes, ten nodes, and so on) are selected from all the nodes. According to some implementations, the first nodes are classified as principal neighbor nodes (e.g., top nodes), and the second nodes are classified as common neighbor nodes.

At 804, first assignment conflicts at the first nodes are determined based on a first weight, and second assignment conflicts at the second nodes are determined based on a second weight different than the first weight. For example, the second weight can have a lesser importance than the first weight. In other words, the first weight can result in a stringent conflict criterion and the second weight can result in a relaxed conflict criterion. Thus, based on the first weight, a module-k conflict is not allowed for the first nodes and based on the second weight, the module-k conflict is allowed for the second nodes. The relaxation of the module-k conflicts for the second nodes can be relaxed gradually in order to find a feasible solution.

According to some implementations, determination of the first assignment conflicts and the second assignment conflicts includes determining first module-k assignments for the first nodes and second module-k assignments for the second nodes. In some implementations, the first assignment conflicts include first collisions resulting from first neighboring nodes of the first nodes determined to be assigned a first same physical cell identifier. Further, the second assignment conflicts include second collisions resulting from second neighboring nodes of the second nodes determined to be assigned a second same physical cell identifier.

Further, at 806, physical cell identifiers are assigned to the group of nodes. Assigning the PCIs can include assigning respective first physical cell identifiers of the physical cell identifiers to the first nodes, at 808. The assignment of the first PCIs can be based on the determination of the first assignment conflicts. Further, at 810, respective second physical cell identifiers of the physical cell identifiers can be assigned to the second nodes based on the determining of the second assignment conflicts. It is noted that assigning of the respective second physical cell identifiers is after completion of the assigning of the respective first physical cell identifiers. Assignment of the PCIs can include mitigating direct collisions between the group of nodes.

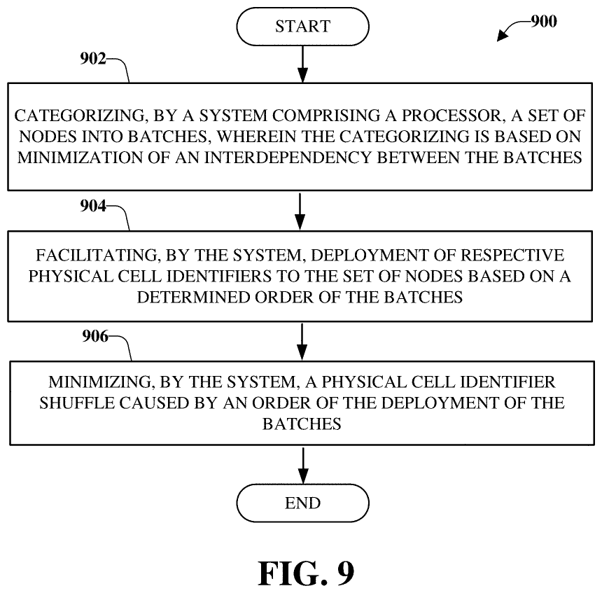

FIG. 9 illustrates an example, non-limiting, computer-implemented method 900 for facilitating deployment of PCIs based on batch processing in accordance with one or more embodiments described herein. The computer-implemented method 900 can be implemented by a system including a memory and a processor, network equipment including a memory and a processor, a network controller including a memory and a processor, or another computer-implemented device including a memory and a processor.

The computer-implemented method starts, at 902, with categorizing a set of nodes into batches. For example, the set of nodes can include first nodes and second nodes, as determined with respect to FIG. 8. Such batching can be performed as discussed with FIG. 4, for example.

Further, at 904, respective PCIs can be deployed at the set of nodes based on a determined order of the batches. For example, first PCIs can be deployed at the first nodes and the second PCIs can be deployed at the second nodes based on the batch processing. According to some implementations, deployment of the PCIs can include, at 906, minimizing a physical cell identifier shuffle caused by an order of the deployment of the batches.

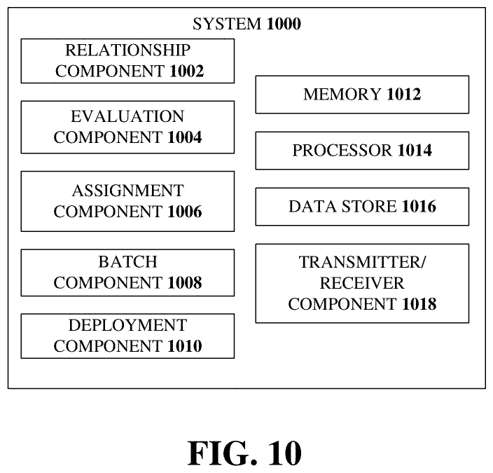

FIG. 10 illustrates an example, non-limiting, system 1000 that facilitates PCI assignment and deployment in accordance with one or more embodiments described herein. Repetitive description of like elements employed in other embodiments described herein is omitted for sake of brevity. The system 1000 can be configured to perform functions associated with the process flow 600 of FIG. 6, the process flow 700 of FIG. 7, the computer-implemented method 800 of FIG. 8, the computer-implemented method 900 of FIG. 9, other process flows and/or other computer-implemented methods discussed herein.

Aspects of systems (e.g., the system 1000 and the like), apparatuses, and/or processes (e.g., computer-implemented methods) explained in this disclosure can include machine-executable component(s) embodied within machine(s) (e.g., embodied in one or more computer readable mediums (or media) associated with one or more machines). Such component(s), when executed by the one or more machines (e.g., computer(s), computing device(s), virtual machine(s), and so on) can cause the machine(s) to perform the operations described. In various embodiments, the system 1000 can be any type of component, machine, device, facility, apparatus, and/or instrument that can include a processor and/or can be capable of effective and/or operative communication with a wired and/or wireless network.

The system 1000 can include a relationship component 1002, an evaluation component 1004, an assignment component 1006, a batch component 1008, a deployment component 1010, at least one memory 1012, at least one processor 1014, at least one data store 1016, and a transmitter/receiver component 1018. In various embodiments, one or more of: the relationship component 1002, the evaluation component 1004, the assignment component 1006, the batch component 1008, the deployment component 1010, the at least one memory 1012, the at least one processor 1014, the at least one data store 1016, and the transmitter/receiver component 1018 can be electrically and/or communicatively coupled to one another to perform one or more of the functions of the system 1000. In some embodiments, one or more of: the relationship component 1002, the evaluation component 1004, the assignment component 1006, the batch component 1008, the deployment component 1010, and the transmitter/receiver component 1018 can include software instructions stored on the at least one memory 1012 and/or the at least one data store 1016 and executed by the at least one processor 1014. The system 1000 may also interact with other hardware and/or software components not depicted in FIG. 10.

The relationship component 1002 can determine relationship statuses of network equipment that are undergoing PCI assignment as discussed herein. The relationship statuses can be based on a number of user equipment that is handed over between the network equipment. Thus, pairs of network equipment can be associated with a number of handovers between the pairs of network equipment.

The evaluation component 1004 can divide the network equipment into two groups, where a first group of network equipment is determined to have a first relationship status and a second group of network equipment is determined to have a second relationship status. The respective relationship statuses can be based on a first quantity of handovers of user equipment between respective first network equipment of the first group of network equipment being more than a second quantity of handovers of user equipment between respective second network equipment of the second group of network equipment. Thus, the evaluation component 1004 can identify the first group of network equipment that includes a first relationship status and the second group of network equipment that includes a second relationship status. The first relationship status and the second relationship status are different statuses. For example, the first relationship status can be a status associated with top neighbors as discussed with respect to FIG. 2B. As mentioned, the determination of top neighbors might not be symmetric such that network equipment A might be a top neighbor of network equipment B, but network equipment B might not be a top neighbor of network equipment A.

The assignment component 1006 can determine a first assignment of first identifiers of a group of identifiers for the first group of network equipment. The first identifiers are PCI assignments, and the group of identifiers are the available PCI assignments available for use. The determination of the assignment of the first identifiers can be based on a first application of first assignment conflicts. For example, the first assignment conflicts can be conflicts with one or more network equipment that are considered to be blocked network equipment whose identifiers (e.g., PCIs) are not to be changed. In another example, the first assignment conflicts can be module-K conflicts or other conflicts. Thus, determination of the first assignment of first identifiers can include resolving module-k conflicts among the first group of network equipment (and the second group of network equipment).

Further, the assignment component 1006 can determine a second assignment of second identifiers (e.g., PCI assignments) of the group of identifiers for the second group of network equipment. The determination of the second assignment of second identifiers can be based on a second application of second assignment conflicts (e.g., blocked network equipment, module k conflicts, and so on). For example, determination of the second assignment of second identifiers can include resolving module-k conflicts among the second group of network equipment (and the first group of network equipment).

According to some implementations, determination of the first assignment of first identifiers and the determination of the second assignment of second identifiers can be performed by the assignment component 1006 at substantially a same time. As such, PCI assignments can be enabled based on consideration of not only PCI assignments to top neighbors but also PCI assignment to common neighbors (e.g., all neighboring network equipment).

In some implementations, the first application of first assignment conflicts can include applying a first rule associated with a module-k assignment to the first group of network equipment. Further, the second application of second assignment conflicts can include a second rule associated with the module-k assignment to the second group of network equipment. The second rule can be less stringent than the first rule. For example, a rule can be more stringent based on the first network equipment being top neighbors, while the same rule is less stringent or relaxed based on the second network equipment being common neighbors.

Further, the batch component 1008 can apply batch processing of first network equipment of the first group of network equipment and second network equipment of the second group of network equipment. Such batch processing by the batch component 1008 can result in batches of network equipment. For example, the batches of network equipment can include a first batch of network equipment and at least a second batch of network equipment.

The application of the batch processing by the batch component 1008 can be performed while mitigating and/or reducing an interdependency between the first batch of network equipment and at least the second batch of network equipment. For example, mitigating and/or reducing the interdependency includes ordering a deployment of the batches of network equipment based on minimization of a physical cell identifier shuffle among the batches of network equipment.

Based on the application of the batch processing, the deployment component 1010 can deploy the first assignment of first identifiers at the first group of network equipment and the second assignment of second identifiers at the second group of network equipment.

With continuing reference to FIG. 10, the at least one memory 1012 can be operatively connected to the at least one processor 1014. The at least one memory 1012 and/or the at least one data store 1016 can store executable instructions that, when executed by the at least one processor 1014 can facilitate performance of operations. Further, the at least one processor 1014 can be utilized to execute computer executable components stored in the at least one memory 1012 and/or the at least one data store 1016.

For example, the at least one memory 1012 can store protocols associated with PCI assignment and deployment as discussed herein. Further, the at least one memory 1012 can facilitate action to control communication between the system 1000, other apparatuses, other systems, equipment, network equipment, and/or user equipment associated with the categories under consideration, and so on, such that the system 1000 can employ stored protocols and/or processes to facilitate load balancing of resources as described herein.

It should be appreciated that data stores (e.g., memories) components described herein can be either volatile memory or nonvolatile memory, or can include both volatile and nonvolatile memory. By way of example and not limitation, nonvolatile memory can include read only memory (ROM), programmable ROM (PROM), electrically Programmable ROM (EPROM), Electrically Erasable ROM (EEPROM), or flash memory. Volatile memory can include Random Access Memory (RAM), which acts as external cache memory. By way of example and not limitation, RAM is available in many forms such as Synchronous RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM), and Direct Rambus RAM (DRRAM). Memory of the disclosed aspects are intended to include, without being limited to, these and other suitable types of memory.

The at least one processor 1014 can facilitate respective deployment of parallel processing as discussed herein. The at least one processor 1014 can be a processor dedicated to analyzing and/or generating information received, a processor that controls one or more components of the system 1000, and/or a processor that both analyzes and generates information received and controls one or more components of the system 1000.

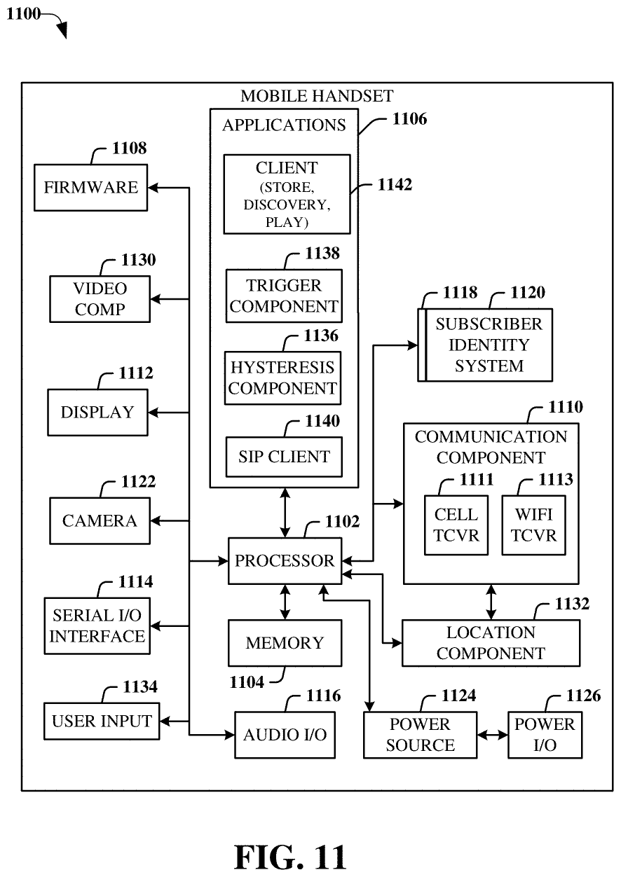

Described herein are systems, methods, articles of manufacture, non-transitory machine-readable medium, and other embodiments or implementations that can facilitate assignment of physical cell identifier under technological and operational constraints. Referring now to FIG. 11, illustrated is an example, non-limiting, block diagram of a handset 1100 operable to engage in a system architecture that facilitates wireless communications according to one or more embodiments described herein. Although a mobile handset is illustrated herein, it will be understood that other devices can be a mobile device, and that the mobile handset is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information, and which can be accessed by the computer.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset includes a processor 1102 for controlling and processing all onboard operations and functions. A memory 1104 interfaces to the processor 1102 for storage of data and one or more applications 1106 (e.g., a video player software, user feedback component software, etc.). Other applications can include voice recognition of predetermined voice commands that facilitate initiation of the user feedback signals. The applications 1106 can be stored in the memory 1104 and/or in a firmware 1108, and executed by the processor 1102 from either or both the memory 1104 or/and the firmware 1108. The firmware 1108 can also store startup code for execution in initializing the handset 1100. A communications component 1110 interfaces to the processor 1102 to facilitate wired/wireless communication with external systems, e.g., cellular networks, VoIP networks, and so on. Here, the communications component 1110 can also include a suitable cellular transceiver 1111 (e.g., a GSM transceiver) and/or an unlicensed transceiver 1113 (e.g., Wi-Fi, WiMax) for corresponding signal communications. The handset 1100 can be a device such as a cellular telephone, a PDA with mobile communications capabilities, and messaging-centric devices. The communications component 1110 also facilitates communications reception from terrestrial radio networks (e.g., broadcast), digital satellite radio networks, and Internet-based radio services networks.

The handset 1100 includes a display 1112 for displaying text, images, video, telephony functions (e.g., a Caller ID function), setup functions, and for user input. For example, the display 1112 can also be referred to as a “screen” that can accommodate the presentation of multimedia content (e.g., music metadata, messages, wallpaper, graphics, etc.). The display 1112 can also display videos and can facilitate the generation, editing and sharing of video quotes. A serial I/O interface 1114 is provided in communication with the processor 1102 to facilitate wired and/or wireless serial communications (e.g., USB, and/or IEEE 1394) through a hardwire connection, and other serial input devices (e.g., a keyboard, keypad, and mouse). This can support updating and troubleshooting the handset 1100, for example. Audio capabilities are provided with an audio I/O component 1116, which can include a speaker for the output of audio signals related to, for example, indication that the user pressed the proper key or key combination to initiate the user feedback signal. The audio I/O component 1116 also facilitates the input of audio signals through a microphone to record data and/or telephony voice data, and for inputting voice signals for telephone conversations.

The handset 1100 can include a slot interface 1118 for accommodating a SIC (Subscriber Identity Component) in the form factor of a card Subscriber Identity Module (SIM) or universal SIM 1120, and interfacing the SIM card 1120 with the processor 1102. However, it is to be appreciated that the SIM card 1120 can be manufactured into the handset 1100, and updated by downloading data and software.

The handset 1100 can process IP data traffic through the communications component 1110 to accommodate IP traffic from an IP network such as, for example, the Internet, a corporate intranet, a home network, a person area network, etc., through an ISP or broadband cable provider. Thus, VoIP traffic can be utilized by the handset 1100 and IP-based multimedia content can be received in either an encoded or decoded format.

A video processing component 1122 (e.g., a camera) can be provided for decoding encoded multimedia content. The video processing component 1122 can aid in facilitating the generation, editing, and sharing of video quotes. The handset 1100 also includes a power source 1124 in the form of batteries and/or an AC power subsystem, which power source 1124 can interface to an external power system or charging equipment (not shown) by a power I/O component 1126.

The handset 1100 can also include a video component 1130 for processing video content received and, for recording and transmitting video content. For example, the video component 1130 can facilitate the generation, editing and sharing of video quotes. A location tracking component 1132 facilitates geographically locating the handset 1100. As described hereinabove, this can occur when the user initiates the feedback signal automatically or manually. A user input component 1134 facilitates the user initiating the quality feedback signal. The user input component 1134 can also facilitate the generation, editing and sharing of video quotes. The user input component 1134 can include such conventional input device technologies such as a keypad, keyboard, mouse, stylus pen, and/or touchscreen, for example.

Referring again to the applications 1106, a hysteresis component 1136 facilitates the analysis and processing of hysteresis data, which is utilized to determine when to associate with the access point. A software trigger component 1138 can be provided that facilitates triggering of the hysteresis component 1136 when the Wi-Fi transceiver 1113 detects the beacon of the access point. A SIP client 1140 enables the handset 1100 to support SIP protocols and register the subscriber with the SIP registrar server. The applications 1106 can also include a client 1142 that provides at least the capability of discovery, play and store of multimedia content, for example, music.

The handset 1100, as indicated above related to the communications component 1110, includes an indoor network radio transceiver 1113 (e.g., Wi-Fi transceiver). This function supports the indoor radio link, such as IEEE 802.11, for a dual-mode GSM handset. The handset 1100 can accommodate at least satellite radio services through a handset that can combine wireless voice and digital radio chipsets into a single handheld device.

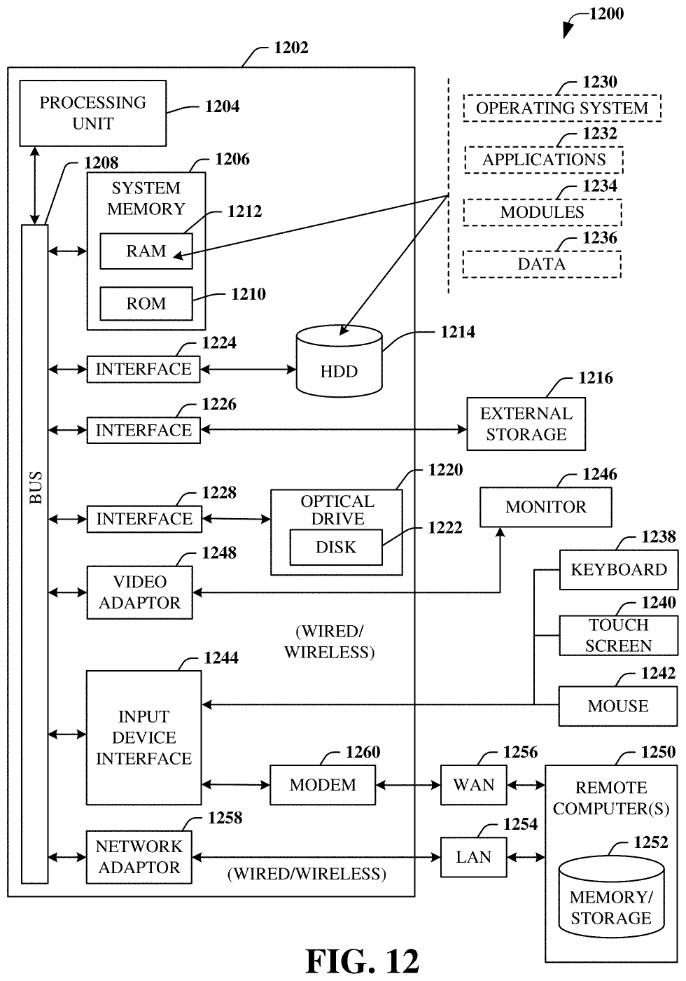

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A Basic Input/Output System (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and a drive 1220, e.g., such as a solid state drive, an optical disk drive, which can read or write from a disk 1222, such as a CD-ROM disc, a DVD, a BD, etc. Alternatively, where a solid state drive is involved, disk 1222 would not be included, unless separate. While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and drive 1220 can be connected to the system bus 1208 by an HDD interface 1224, an external storage interface 1226 and a drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally include emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can include one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enable with a security module, such as a trusted processing module (TPM). For example, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above, such as but not limited to a network virtual machine providing one or more aspects of storage or processing of information. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

An aspect of 5G, which differentiates from previous 4G systems, is the use of NR. NR architecture can be designed to support multiple deployment cases for independent configuration of resources used for RACH procedures. Since the NR can provide additional services than those provided by LTE, efficiencies can be generated by leveraging the pros and cons of LTE and NR to facilitate the interplay between LTE and NR, as discussed herein.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

As used in this disclosure, in some embodiments, the terms “component,” “system,” “interface,” and the like are intended to refer to, or can include a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. As yet another example, a component can be an apparatus that provides specific functionality through electronic components without mechanical parts, the electronic components can include a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “mobile device equipment,” “mobile station,” “mobile,” subscriber station,” “access terminal,” “terminal,” “handset,” “communication device,” “mobile device,” “user equipment” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “Node B (NB),” “evolved Node B (eNode B),” “home Node B (HNB)” and the like, are utilized interchangeably in the application, and refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, including, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.XX wireless technologies and/or legacy telecommunication technologies.

The various aspects described herein can relate to New Radio (NR), which can be deployed as a standalone radio access technology or as a non-standalone radio access technology assisted by another radio access technology, such as Long Term Evolution (LTE), for example. It should be noted that although various aspects and embodiments have been described herein in the context of 5G, Universal Mobile Telecommunications System (UMTS), and/or Long Term Evolution (LTE), or other next generation networks, the disclosed aspects are not limited to 5G, 6G, a UMTS implementation, and/or an LTE implementation as the techniques can also be applied in 3G, 4G, or LTE systems. For example, aspects or features of the disclosed embodiments can be exploited in substantially any wireless communication technology. Such wireless communication technologies can include UMTS, Code Division Multiple Access (CDMA), Wi-Fi, Worldwide Interoperability for Microwave Access (WiMAX), General Packet Radio Service (GPRS), Enhanced GPRS, Third Generation Partnership Project (3GPP), LTE, Third Generation Partnership Project 2 (3GPP2) Ultra Mobile Broadband (UMB), High Speed Packet Access (HSPA), Evolved High Speed Packet Access (HSPA+), High-Speed Downlink Packet Access (HSDPA), High-Speed Uplink Packet Access (HSUPA), Zigbee, or another IEEE 802.XX technology. Additionally, substantially all aspects disclosed herein can be exploited in legacy telecommunication technologies.

As used herein, “5G” can also be referred to as NR access. Accordingly, systems, methods, and/or machine-readable storage media for facilitating link adaptation of downlink control channel for 5G systems are desired. As used herein, one or more aspects of a 5G network can include, but is not limited to, data rates of several tens of megabits per second (Mbps) supported for tens of thousands of users; at least one gigabit per second (Gbps) to be offered simultaneously to tens of users (e.g., tens of workers on the same office floor); several hundreds of thousands of simultaneous connections supported for massive sensor deployments; spectral efficiency significantly enhanced compared to 4G; improvement in coverage relative to 4G; signaling efficiency enhanced compared to 4G; and/or latency significantly reduced compared to LTE.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification procedures and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
determining, by a system comprising a processor, that first nodes of a group of nodes satisfy a defined threshold criterion and that second nodes of the group of nodes fail to satisfy the defined threshold criterion;
determining, by the system, first assignment conflicts at the first nodes based on a first weight, and second assignment conflicts at the second nodes based on a second weight different than the first weight;
assigning, by the system, physical cell identifiers to the group of nodes, wherein the assigning comprises:
assigning respective first physical cell identifiers of the physical cell identifiers to the first nodes based on the determining of the first assignment conflicts; and
assigning respective second physical cell identifiers of the physical cell identifiers to the second nodes based on the determining of the second assignment conflicts, wherein the assigning of the respective second physical cell identifiers is after completion of the assigning of the respective first physical cell identifiers.

2. The method of claim 1, further comprising:
categorizing, by the system, the first nodes and the second nodes into batches, wherein the categorizing is based on minimization of an interdependency between the batches; and
facilitating, by the system, deployment of the respective first physical cell identifiers to the first nodes, and deployment of the respective second physical cell identifiers to the second nodes based on a determined order of the batches.

3. The method of claim 2, wherein the facilitating comprises minimizing a physical cell identifier shuffle caused by an order of the deployment of the batches.

4. The method of claim 1, wherein the determining of the first assignment conflicts and the second assignment conflicts comprises determining first module-k assignments for the first nodes and second module-k assignments for the second nodes.

5. The method of claim 1, wherein the first assignment conflicts comprise first collisions resulting from first neighboring nodes of the first nodes determined to be assigned a first same physical cell identifier, and wherein the second assignment conflicts comprise second collisions resulting from second neighboring nodes of the second nodes determined to be assigned a second same physical cell identifier.

6. The method of claim 1, wherein the second weight has a lesser importance than the first weight.

7. The method of claim 6, wherein, based on the second weight, a module-k conflict is allowed for the second nodes.

8. The method of claim 1, wherein the defined threshold criterion comprises a defined performance indicator associated with neighboring nodes of the group of nodes.

9. The method of claim 1, wherein the first nodes are classified as principal neighbor nodes, and wherein the second nodes are classified as common neighbor nodes.

10. The method of claim 1, wherein the assigning comprises mitigating direct collisions between the group of nodes.

11. A system, comprising:
a processor; and
a memory that stores executable instructions that, when executed by the processor, facilitate performance of operations, comprising:
identifying a first group of network equipment that comprises a first relationship status and a second group of network equipment that comprises a second relationship status different than the first relationship status;
determining a first assignment of first identifiers of a group of identifiers for the first group of network equipment based on a first application of first assignment conflicts; and
determining a second assignment of second identifiers of the group of identifiers for the second group of network equipment based on a second application of second assignment conflicts.

12. The system of claim 11, wherein the first application of first assignment conflicts comprises applying a first rule associated with a module-k assignment to the first group of network equipment, wherein the second application of second assignment conflicts comprises a second rule associated with the module-k assignment to the second group of network equipment, and wherein the second rule is less stringent than the first rule.

13. The system of claim 11, wherein the operations further comprise:
applying batch processing of first network equipment of the first group of network equipment and second network equipment of the second group of network equipment, resulting in batches of network equipment, wherein the batches of network equipment comprise a first batch of network equipment and at least a second batch of network equipment, and wherein the applying comprises mitigating an interdependency between the first batch of network equipment and at least the second batch of network equipment.

14. The system of claim 13, wherein the operations further comprise:
based on the applying, deploying the first assignment of first identifiers at the first group of network equipment and the second assignment of second identifiers at the second group of network equipment.

15. The system of claim 13, wherein the mitigating of the interdependency comprises ordering a deployment of the batches of network equipment based on minimization of a physical cell identifier shuffle among the batches of network equipment.

16. The system of claim 11, wherein the operations further comprise:
determining the first relationship status based on performance indicator.

17. The system of claim 11, wherein the determining of the first assignment of first identifiers comprises resolving module-k conflicts among the first group of network equipment.

18. A non-transitory machine-readable medium, comprising executable instructions that, when executed by a processor, facilitate performance of operations, comprising:
determining first assignment conflicts among first network equipment determined to be first neighboring equipment supporting a first performance indicator, and second assignment conflicts between second network equipment determined to be second neighboring equipment supporting a second performance indicator;
based on the first network equipment having a higher priority assignment as compared to the second network equipment, establishing an assignment list for the first network equipment and the second network equipment, wherein the assignment list is configured to resolve the first assignment conflicts and the second assignment conflicts, and wherein the higher priority assignment is determined based on the first performance indicator; and
facilitating a deployment of the assignment list for the first network equipment and the second network equipment based on the establishing.

19. The non-transitory machine-readable medium of claim 18, wherein the facilitating comprises grouping the first network equipment and the second network equipment based on minimization of shuffling of the assignment list, and wherein the shuffling is caused by two or more network equipment having a same identifier after the deployment.

20. The non-transitory machine-readable medium of claim 18, wherein the assignment list comprises an assignment of respective physical cell identifiers to the first network equipment and the second network equipment.
